(19) United States
(12) Patent Application Publication
(10) Pub. No.: US 2026/0136285 A1
(43) Pub. Date: May 14, 2026

(54) MONITORING METHOD AND APPARATUS, AND COMMUNICATION DEVICE AND STORAGE MEDIUM

(71) Applicant: Beijing Xiaomi Mobile Software Co., Ltd., Beijing (CN)

(72) Inventor: Yanhua LI, Beijing (CN)

(73) Assignee: Beijing Xiaomi Mobile Software Co., Ltd., Beijing (CN)

(21) Appl. No.: 18/847,022

(22) PCT Filed: Mar. 16, 2022
(86) PCT No.: PCT/CN2022/081171

§ 371 Date: Sep. 13, 2024

(51) Int. Cl. H04W 52/02; H04W 68/02

(52) U.S. Cl. CPC H04W 52/0235; H04W 68/02

(57) ABSTRACT

A monitoring method is performed by a terminal and includes: on the basis of a determination result of whether a first transceiver of the terminal detects a power-saving signal, determining a processing operation for a second transceiver of the terminal.

### CROSS-REFERENCE TO RELATED APPLICATIONS

The present application is a U.S. National Stage of International Application No. PCT/CN2022/081171, filed on Mar. 16, 2022, the disclosure of which is incorporated herein by reference in its entirety for all purposes.

### TECHNICAL FIELD

The present disclosure relates to, but is not limited to, the field of wireless communication technology, and in particular to a monitoring method and apparatus, a communication device, and a storage medium.

### BACKGROUND

In related art, in a discontinuous reception (DRX) scenario in a Radio Resource Control (RRC) idle state, a power saving signal is usually configured before a Paging Occasion (PO). If the terminal does not detect the power saving signal, it needs to ignore paging Downlink Control Information (DCI), otherwise, it needs to monitor the paging DCI.

### SUMMARY

The embodiments of the present disclosure disclose a monitoring method and apparatus, a communication device and a storage medium.

According to a first aspect of an embodiment of the present disclosure, a monitoring method is provided, the method is performed by a terminal, and the method includes: determining, based on a determination result of whether a power saving signal is detected by a first transceiver of the terminal, a processing operation for a second transceiver of the terminal.

According to a second aspect of an embodiment of the present disclosure, a monitoring apparatus is provided, and the apparatus includes: a determination module, configured to determine, based on a determination result of whether a power saving signal is detected by a first transceiver of a terminal, a processing operation for a second transceiver of the terminal.

According to a third aspect of an embodiment of the present disclosure, a communication device is provided, the communication device including: a processor; and a memory configured to instructions executable by the processor; where the processor is configured to implement the method according to any of the embodiments of the present disclosure when running the executable instructions.

According to a fourth aspect of an embodiment of the present disclosure, there is provided a computer storage medium that stores a computer executable program which, when being executed by a processor, implements the method according to any of the embodiments of the present disclosure.

### BRIEF DESCRIPTION OF THE DRAWINGS

FIG. 1 is a schematic structural diagram of a wireless communication system according to an illustrative embodiment.

FIG. 2 is a schematic flow chart of a monitoring method according to an illustrative embodiment.

FIG. 3 is a schematic flow chart of a monitoring method according to an illustrative embodiment.

FIG. 4 is a schematic flow chart of a monitoring method according to an illustrative embodiment.

FIG. 5 is a schematic flow chart of a monitoring method according to an illustrative embodiment.

FIG. 6 is a schematic flow chart of a monitoring method according to an illustrative embodiment.

FIG. 7 is a schematic flow chart of a monitoring method according to an illustrative embodiment.

FIG. 8 is a schematic flow chart of a monitoring method according to an illustrative embodiment.

FIG. 9 is a schematic flow chart of a monitoring method according to an illustrative embodiment.

FIG. 10 is a schematic diagram of a monitoring apparatus according to an illustrative embodiment.

FIG. 11 is a schematic structural diagram of a terminal according to an illustrative embodiment.

FIG. 12 is a block diagram of a base station according to an illustrative embodiment.

### DETAILED DESCRIPTION

Illustrative embodiments will be described in detail herein, examples of which are shown in the accompanying drawings. When the following description refers to the drawings, the same numbers in different drawings represent the same or similar elements unless otherwise indicated. The implementations described in the following illustrative embodiments do not represent all implementations consistent with the embodiments of the present disclosure. Rather, they are merely examples of devices and methods consistent with some aspects of the embodiments of the present disclosure as detailed in the appended claims.

The terms used in the embodiments of the present disclosure are only for the purpose of describing specific embodiments and are not intended to limit the embodiments of the present disclosure. The singular forms of “a” and “the” used in the embodiments of the present disclosure and the appended claims are also intended to include plural forms unless the context clearly indicates other meanings. It should also be understood that the term “and/or” used herein refers to and includes any or all possible combinations of one or more associated items listed.

It should be understood that although the terms such as first, second, third, etc. may be used to describe various information in the embodiments of the present disclosure, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein may be interpreted as “at the time of” or “when” or “in response to determining”.

For the purpose of brevity and ease of understanding, the terms “greater than” or “less than” are used herein to indicate size relationships. However, those skilled in the art can understand that the term “greater than” also encompasses the meaning of “greater than or equal to”, and “less than” also encompasses the meaning of “less than or equal to”.

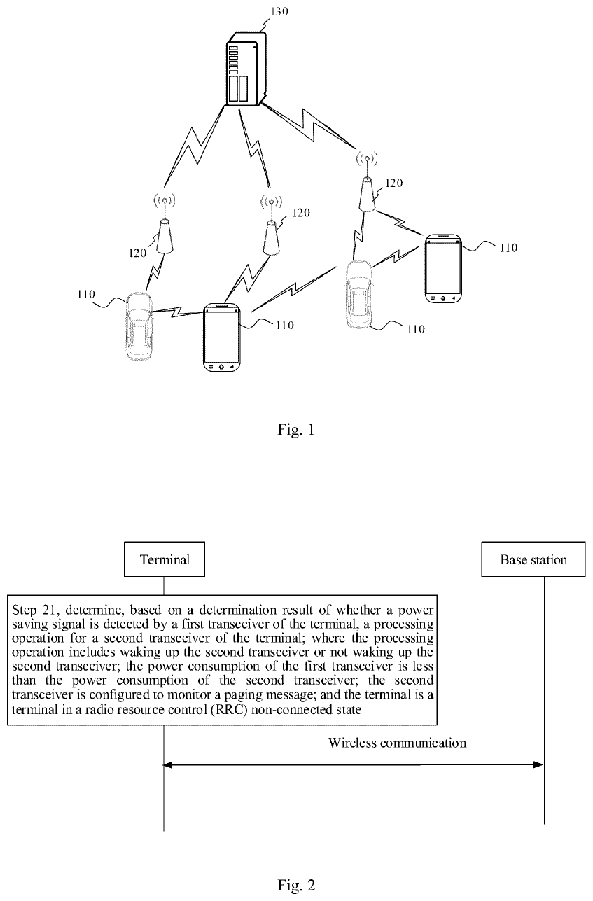

Refer to FIG. 1, which shows a schematic diagram of the structure of a wireless communication system provided by an embodiment of the present disclosure. As shown in FIG. 1, the wireless communication system is a communication system based on mobile communication technology, and the wireless communication system may include: a plurality of User Equipment 110 and a plurality of base stations 120.

The user equipment 110 can be a device that provides voice and/or data connectivity to the user. The user equipment 110 can communicate with one or more core networks via a Radio Access Network (RAN), and the user equipment 110 can be an Internet of Things user equipment, such as a sensor device, a mobile phone, and a computer with an Internet of Things user equipment, which can be, for example, a fixed, portable, pocket-sized, handheld, computer-built-in or vehicle-mounted device, such as a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 can also be a device of an unmanned aerial vehicle. Alternatively, the user equipment 110 can also be a vehicle-mounted device, for example, it can be a driving computer with wireless communication function, or a wireless user device connected to an external driving computer. Alternatively, the user equipment 110 may also be a roadside device, such as a street lamp, a signal lamp, or other roadside devices that have a wireless communication function.

The base station 120 may be a network-side device in a wireless communication system. The wireless communication system may be a 4th generation mobile communication technology (4G) system, also known as a long term evolution (LTE) system; or the wireless communication system may be a 5G system, also known as a new radio system or a 5G NR system. Alternatively, the wireless communication system may be a next generation system of the 5G system. The access network in the 5G system may be referred to as a New Generation-Radio Access Network (NG-RAN).

The base station 120 can be an evolved base station (eNB) adopted in a 4G system. Alternatively, the base station 120 can also be a base station (gNB) adopting a central distributed architecture in a 5G system. When adopting the central distributed architecture, the base station 120 generally includes a central unit (CU) and at least two distributed units (DU). The central unit is provided with protocol stacks of a Packet Data Convergence Protocol (PDCP) layer, a Radio Link Layer Control (RLC) layer, and a Media Access Control (MAC) layer; the distributed unit is provided with a physical (PHY) layer protocol stack. The specific implementations of the base station 120 are not limited in the embodiments of the present disclosure.

A wireless connection may be established between the base station 120 and the user equipment 110 via a radio interface. In different implementations, the radio interface is a radio interface based on the 4th generation mobile communication network technology (4G) standard; or, the radio interface is a radio interface based on the 5th generation mobile communication network technology (5G) standard, for example, the radio interface is a new radio interface; or, the radio interface may also be a radio interface based on the next generation mobile communication network technology standard of 5G.

In some embodiments, an End to End (E2E) connection may also be established between the user devices 110, such as vehicle to vehicle (V2V) communication, vehicle to Infrastructure (v) communication, and vehicle to pedestrian (V2P) communication in vehicle to everything (V2X) communication.

Herein, the above user equipment can be considered as the terminal device in the following embodiments.

In some embodiments, the wireless communication system may further include a network management device 130.

The plurality of base stations 120 are respectively connected to the network management device 130. The network management device 130 may be a core network device in a wireless communication system, for example, the network management device 130 may be a Mobility Management Entity (MME) in an Evolved Packet Core (EPC). Alternatively, the network management device may also be other core network devices, such as a Serving GateWay (SGW), a Public Data Network GateWay (PGW), a Policy and Charging Rules Function (PCRF), or a Home Subscriber Server (HSS). The implementation forms of the network management device 130 are not limited in the embodiments of the present disclosure.

In order to facilitate the understanding of those skilled in the art, there are provided a plurality of implementation in the embodiments of the present disclosure so as to clearly illustrate the technical solutions of the embodiments of the present disclosure. Of course, those skilled in the art can understand that the plurality of embodiments provided in the embodiments of the present disclosure can be executed separately, or can be executed together with the methods of other embodiments in the embodiments of the present disclosure, or can be executed together with some methods in other related technologies separately or in combination, which is not limited in the embodiments of the present disclosure.

In order to better understand the technical solutions described in any of the embodiments of the present disclosure, the application scenarios in the related technologies are explained first.

In an embodiment, a power saving signal is introduced for the RRC connected state, namely, a Wakeup signal or DCI for Powersaving (DCP). The power signal is a low power consumption detection signal. If the terminal detects the power saving signal, the terminal needs to monitor a Physical Downlink Control Channel (PDCCH). However, if the power saving signal is not detected, the monitoring of the PDCCH can be ignored.

In an embodiment, for the DRX scenario in the RRC idle state, the power saving signal (such as a Paging Early Indication (PEI)) is usually configured before the PO. If the terminal does not detect the power saving signal, it needs to ignore the Paging DCI, otherwise, it needs to monitor the Paging DCI.

In an embodiment, the RRC connection state is enhanced by introducing PDCCH Skipping mechanism, that is, the PDCCH Skipping will be carried in the DCI to notify the terminal to skip monitoring for a period of time or to switch the search space group.

It should be noted that for whatever kind of power saving signal, a modem of the terminal needs to detect the power saving signal. In an embodiment, a separate transceiver (low power wake-up receiver) is introduced to receive the power saving signal, and the modem part or a main radio part of the terminal can be woke up only after being woke up by the separate transceiver, otherwise the modem part will remain in a sleep state. In an embodiment, the power saving signal received by the separate transceiver is called a wake-up signal or a paging early indication, and the power saving signal has characteristics of low power or Almost Zero Power (AZP).

As shown in FIG. 2, this embodiment provides a monitoring method, the method is performed by a terminal, and the method includes the following.

In step 21, it determines, based on a determination result of whether a power saving signal is detected by a first transceiver of the terminal, a processing operation for a second transceiver of the terminal.

The processing operation includes: waking up the second transceiver or not waking up the second transceiver; the power consumption of the first transceiver is less than the power consumption of the second transceiver; the second transceiver is configured to monitor a paging message; and the terminal is a terminal in a radio resource control (RRC) non-connected state.

In the embodiments of the present disclosure, the processing operation of the second transceiver of the terminal is determined based on the determination result of whether the first transceiver of the terminal detects the power saving signal. Since the processing operation of the second transceiver of the terminal is determined based on the determination result of whether the first transceiver detects the power saving signal, the processing operation can be adapted to the determination result, and compared with the method of directly using the second transceiver to monitor the power saving signal, the power consumption of the first transceiver can be less than the power consumption of the second transceiver. As such, the energy consumption of the terminal can be saved and the battery life of the terminal can be prolonged.

In an embodiment, the first transceiver is a low power wake-up receiver or an almost zero power wake-up receiver.

In an embodiment, the second transceiver is a main receiver main receiver, a modem, or a main radio.

The terminal involved in the present disclosure may be, but is not limited to, a mobile phone, a wearable device, a vehicle-mounted terminal, a Road Side Unit (RSU), a smart home terminal, an industrial sensor device and/or a medical device, etc. The terminal in the RRC non-connected state includes: a terminal in an RRC idle state and a terminal in an RRC inactive state.

The network involved in the present disclosure may refer to an access network or a core network. Herein, the network may be various types of networks, for example, a third generation mobile communication (3G) network, a fourth generation mobile communication (4G) network, a fifth generation mobile communication (5G) network or other evolved networks.

Herein, the power saving signal may be PEI. The first transceiver may be an ultra-low power wake-up receiver.

In an embodiment, in response to the terminal being in an RRC non-connected state, the processing operation for the second transceiver of the terminal is determined based on the determination result of whether the first transceiver of the terminal detects the power saving signal, the processing operation includes waking up the second transceiver or not waking up the second transceiver, the power consumption of the first transceiver is less than the power consumption of the second transceiver, and the second transceiver is used to monitor a paging message.

It should be noted that the terminal includes at least one first transceiver and at least one second transceiver. In an embodiment, at least one first transceiver may be configured for each second transceiver.

In an embodiment, in response to the terminal being in the RRC non-connected state, the terminal monitors the power saving signal through the first transceiver, the processing operation for the second transceiver of the terminal is determined based on the determination result of whether the first transceiver of the terminal detects the power saving signal, and in response to determining that the power saving signal is detected, it is determined to wake up the second transceiver; and/or, in response to determining that the power saving signal is not detected, it is determined not to wake up the second transceiver, and in response to the second transceiver being woke up, monitoring of the paging message is started using the second transceiver.

In an embodiment, the processing operation for the second transceiver of the terminal is determined based on the determination result of whether the first transceiver of the terminal detects the power saving signal within a predetermined time period. For example, in response to that the first transceiver of the terminal detects the power saving signal within the predetermined time period, it is determined to wake up the second transceiver; or in response to that the first transceiver of the terminal does not detect the power saving signal within the predetermined time period, it is determined not to wake up the second transceiver. Here, not detecting the power saving signal within the predetermined time period may be due to a timeout for the first transceiver to monitor the power saving signal. It should be noted that the determining the processing operation for the second transceiver of the terminal may also be triggered based on other predetermined trigger events, which are not limited here. The predetermined trigger event may be a trigger event associated with the first transceiver.

In an embodiment, a radio resource for the first transceiver to monitor the power saving signal is determined according to predetermined information; the processing operation for the second transceiver of the terminal is determined based on the determination result of whether the first transceiver of the terminal detects the power saving signal on the radio resource; in response to determining that the power saving signal is detected on the radio resource, it is determined to wake up the second transceiver; and/or, in response to determining that the power saving signal is not detected on the radio resource, it is determined not to wake up the second transceiver; and in response to the second transceiver being woke up, monitoring for the paging message is started using the second transceiver. In an embodiment, the predetermined information includes one or more of: network configured information; predetermined rule information sent by a network; or predetermined protocol information.

In an embodiment, the radio resource for the first transceiver to monitor the power saving signal is determined based on network configured information; a single set of power saving signals is monitored on the radio resource indicated by the network configured information, where the single set of power saving signals is used to wake up all terminals; the processing operation for the second transceiver of the terminal is determined based on the determination result of whether the first transceiver of the terminal detects the single set of power saving signals on the radio resource; in response to determining that the single set of power saving signals is detected on the radio resource, it is determined to wake up the second transceiver; and/or, in response to determining that the single set of power saving signals is not detected on the radio resource, it is determined not to wake up the second transceiver; and in response to the second transceiver being woke up, monitoring for the paging message is started the second transceiver.

In an embodiment, the radio resource for the first transceiver to monitor the power saving signal is determined based on the network configured information; a plurality of sets of power saving signals are monitored on the radio resource indicated by the network configured information, where each set of power saving signals is used to wake up terminals in a group corresponding to the set of power saving signals; the group includes at least one terminal. The processing operation for the second transceiver of the terminal is determined based on the determination result of whether the first transceiver of the terminal detects the power saving signal on the radio resource; in response to determining that the power saving signal is detected on the radio resource, it is determined to wake up the second transceiver; and/or, in response to determining that the power saving signal is not detected on the radio resource, it is determined not to wake up the second transceiver; and in response to the second transceiver being woke up, monitoring for the paging message is started using the second transceiver.

In an embodiment, the group to which the terminal belongs is determined based on a terminal identifier UE-ID based subgrouping or based on received predetermined indication information. Different sets of power saving signals may be configured for different groups, and the terminal selects one set of wake-up signals for monitoring based on the UE-ID based subgrouping. The predetermined indication information may directly indicate the group ID, and the terminal may monitor the power saving signal corresponding to the group indicated by the group ID.

In an embodiment, the radio resource for the first transceiver to monitor the power saving signal is determined according to the UE-ID based subgrouping indicated by predetermined information; the processing operation for the second transceiver of the terminal is determined based on the determination result of whether the first transceiver of the terminal detects the power saving signal on the radio resource; in response to determining that the power saving signal is detected on the radio resource, it is determined to wake up the second transceiver; and/or, in response to determining that the power saving signal is not detected on the radio resource, it is determined not to wake up the second transceiver; and in response to the second transceiver being woke up, monitoring for the paging message is started using the second transceiver.

In an embodiment, the terminal monitors the power saving signal through the first transceiver; the processing operation for the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; in response to the second transceiver being woke up, it performs synchronization with a network using the first transceiver; and in response to the second transceiver being woke up and the terminal being synchronized with the network, monitoring for the paging message is started using the second transceiver.

In an embodiment, the terminal monitors the power saving signal through the first transceiver; the processing operation for the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, it performs synchronization with the network using the second transceiver; and in response to the second transceiver being woke up and the terminal being synchronized with the network, monitoring for the paging message is started using the second transceiver.

In an embodiment, the terminal monitors the power saving signal through the first transceiver; the processing operation for the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, periodic monitoring of the paging message is started using the second transceiver, or non-periodic monitoring of the paging message is started using the second transceiver.

In an embodiment, monitoring information for monitoring a paging message sent by a network is received; the monitoring information includes one or more of the following: search space information; control resource set information; offset information relative to a reference time domain position. In response to the terminal being in an RRC non-connected state, the terminal monitors the power saving signal through the first transceiver; the processing operation for the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, monitoring of the paging message is started using the second transceiver and the monitoring information.

In the embodiments of the present disclosure, the processing operation of the second transceiver of the terminal is determined based on the determination result of whether the first transceiver of the terminal detects the power saving signal. Since the processing operation of the second transceiver of the terminal is determined based on the determination result of whether the first transceiver detects the power saving signal, the processing operation can be adapted to the determination result. Compared with the method of directly using the second transceiver to monitor the power saving signal, the power consumption of the first transceiver can be less than the power consumption of the second transceiver. As such, the energy consumption of the terminal can be saved and the battery life of the terminal can be prolonged.

It should be noted that those skilled in the art can understand that the method provided in the embodiment of the present disclosure can be performed alone or together with some methods in the embodiments of the present disclosure or some methods in related arts.

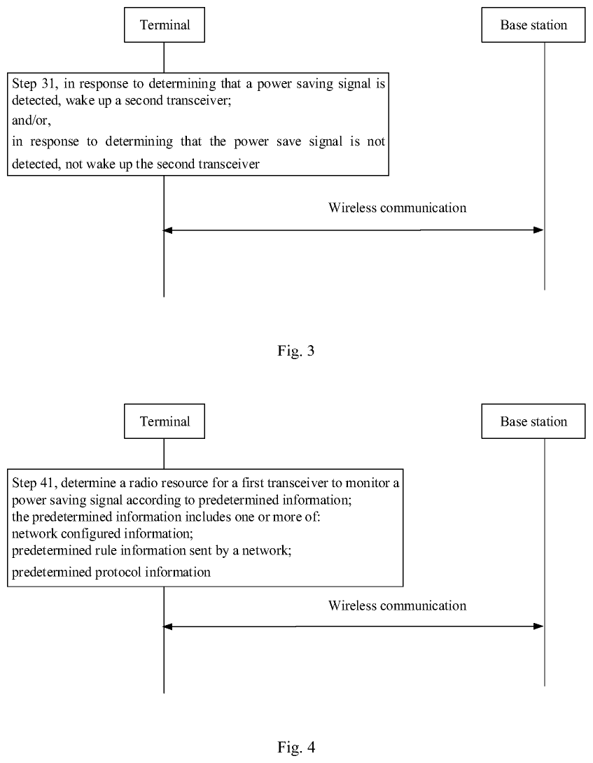

As shown in FIG. 3, an embodiment of the present disclosure provides a monitoring method, the method is performed by a terminal, and the method includes the following.

In step 31, in response to determining that a power saving signal is detected, a second transceiver is woke up; and/or, in response to determining that the power save signal is not detected, the second transceiver is not woke up.

Herein, the second transceiver is used for synchronization between the terminal and the network and/or for monitoring a paging message. Waking up the second transceiver may be to cause the second transceiver to be in a state capable of receiving a message, for example, causing the second transceiver to be in a state capable of receiving a paging message.

In an embodiment, in response to that the first transceiver detects the power saving signal, the second transceiver is woke up; and/or, in response to that the first transceiver does not detect the power saving signal, the second transceiver is not woke up. Herein, the power consumption of the first transceiver is less than the power consumption of the second transceiver. In this way, the power consumption of the terminal can be saved.

In an embodiment, in response to the terminal being in an RRC non-connected state, the terminal monitors the power saving signal through the first transceiver; the processing operation for the second transceiver of the terminal is determined based on a determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, monitoring of a paging message is started using the second transceiver.

It should be noted that those skilled in the art can understand that the method provided in the embodiment of the present disclosure can be performed alone or together with some methods in the embodiments of the present disclosure or some methods in related arts.

As shown in FIG. 4, an embodiment provides a monitoring method, the method is performed by a terminal, and the method includes the following.

In step 41, a radio resource for a first transceiver to monitor a power saving signal is determined according to predetermined information; the predetermined information includes one or more of the following: network configured information; predetermined rule information sent by a network; predetermined protocol information.

In an embodiment, the network sends the power saving signal at a time-domain and/or frequency-domain position indicated by the network configured information. That is, the radio resource is the time-domain and/or frequency-domain position indicated by the network configured information. After determining the time-domain and/or frequency-domain position indicated by the network configured information, the terminal can monitor the power saving signal at the time-domain and/or frequency-domain position.

In an embodiment, the network sends predetermined rule information to the terminal and sends the power saving signal at a time-domain and/or frequency-domain position indicated by the predetermined rule information. After determining the time-domain and/or frequency-domain position indicated by the predetermined rule information, the terminal can monitor the power saving signal at the time-domain and/or frequency-domain position.

In an embodiment, the network sends the power saving signal at a time-domain and/or frequency-domain position indicated by the predetermined protocol information. After determining the time-domain and/or frequency-domain position indicated by the predetermined protocol information, the terminal can monitor the power saving signal at the time-domain and/or frequency-domain position.

It should be noted that those skilled in the art can understand that the method provided in the embodiment of the present disclosure can be performed alone or together with some methods in the embodiments of the present disclosure or some methods in related arts.

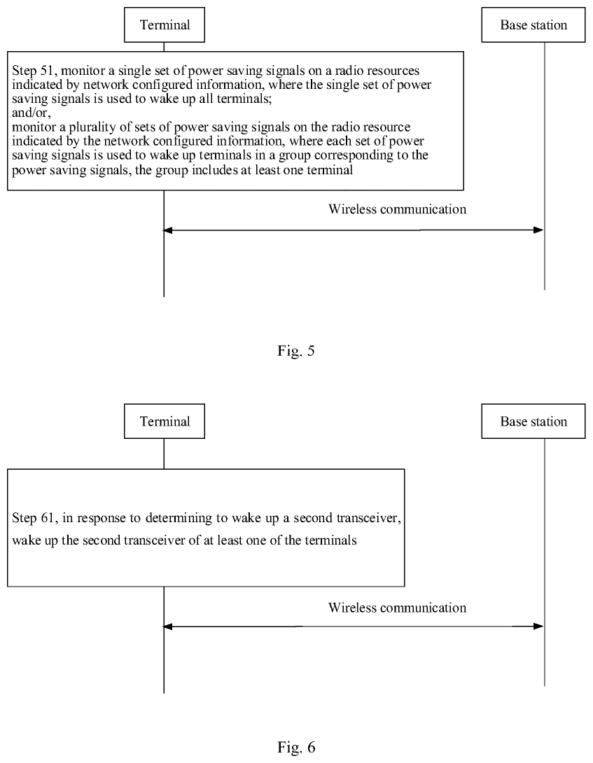

As shown in FIG. 5, an embodiment provides a monitoring method, the method is performed by a terminal, and the method includes the following.

In step 51, a single set of power saving signals is monitored on a radio resources indicated by network configured information, where the single set of power saving signals is used to wake up all terminals; and/or, a plurality of sets of power saving signals are monitored on the radio resource indicated by the network configured information, where each set of power saving signals is used to wake up terminals in a group corresponding to the set of power saving signals; the group includes at least one terminal.

In an embodiment, the network sends a single set of power saving signals to the terminal, where the single set of power saving signals is used to wake up the terminal that supports a predetermined feature. Herein, the predetermined feature may be a feature that the terminal has a first transceiver and a second transceiver. The terminal may monitor the single set of power saving signals on the radio resource indicated by the network configured information. The processing operation for the second transceiver of the terminal is determined based on a determination result of whether the first transceiver of the terminal detects a power saving signal; where the processing operation includes waking up the second transceiver or not waking up the second transceiver; the power consumption of the first transceiver is less than the power consumption of the second transceiver; the second transceiver is used to monitor the paging message; and the terminal is a terminal in a radio resource control (RRC) non-connected state.

In an embodiment, the network sends a plurality of sets of power saving signals to the terminal, where the plurality of sets of power saving signals are used to wake up terminals in groups that support a predetermined feature. Herein, the predetermined feature may be a feature that the terminal has a first transceiver and a second transceiver. The terminals in the groups can monitor the plurality of sets of power saving signals on the radio resource indicated by the network configured information. The processing operation for the second transceiver of the terminal is determined based on the determination result of whether the first transceiver of the terminal detects the power saving signal; where the processing operation includes waking up the second transceiver or not waking up the second transceiver; the power consumption of the first transceiver is less than the power consumption of the second transceiver; the second transceiver is used to monitor the paging message; the terminal is a terminal in a radio resource control (RRC) non-connected state.

It should be noted that those skilled in the art can understand that the method provided in the embodiment of the present disclosure can be performed alone or together with some methods in the embodiments of the present disclosure or some methods in related arts.

In an embodiment, the predetermined information indicates the terminal to determine the radio resource for the first transceiver to monitor the power saving signal based on a UE-ID based subgrouping.

In an embodiment, the radio resource for the first transceiver to monitor the power saving signal is determined according to the UE-ID based subgrouping indicated by the predetermined information; the processing operation of the second transceiver of the terminal is determined based on the determination result of whether the first transceiver of the terminal detects the power saving signal on the radio resource; in response to determining that the power saving signal is detected on the radio resource, it is determined to wake up the second transceiver; and/or, in response to determining that the power saving signal is not detected on the radio resource, it is determined not to wake up the second transceiver; and in response to the second transceiver being woke up, monitoring for the paging message is started using the second transceiver.

As shown in FIG. 6, an embodiment provides a monitoring method, the method is performed by a terminal, and the method includes the following.

In step 61, in response to determining to wake up a second transceiver, the second transceiver of at least one of the terminals is woke up.

In an embodiment, in response to the terminal being in an RRC non-connected state, the terminal monitors a power saving signal through a first transceiver; a processing operation for the second transceiver of the terminal is determined based on a determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; in response to the second transceiver being woke up, the second transceiver of at least one terminal is woke up; and monitoring of a paging message is started using at least one second transceiver.

It should be noted that those skilled in the art can understand that the method provided in the embodiment of the present disclosure can be performed alone or together with some methods in the embodiments of the present disclosure or some methods in related arts.

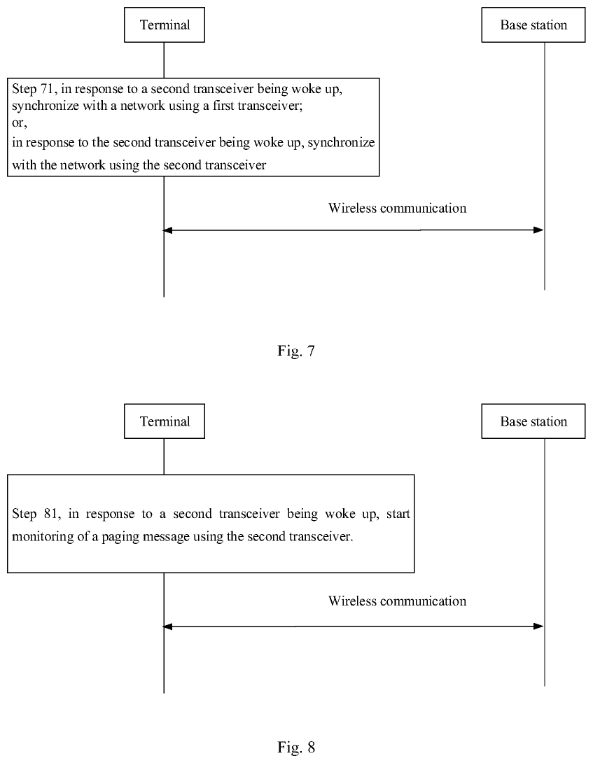

As shown in FIG. 7, an embodiment provides a monitoring method, the method is performed by a terminal, and the method includes the following.

In step 71, in response to a second transceiver being woke up, it performs synchronization with a network using a first transceiver; or, in response to the second transceiver being woke up, it performs synchronization with the network using the second transceiver.

In an embodiment, the terminal monitors the power saving signal through the first transceiver; the processing operation of the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; in response to the second transceiver being woke up, it performs synchronization with the network using the first transceiver; in response to the second transceiver being woke up and the terminal being synchronized with the network, monitoring for the paging message is started using the second transceiver. Herein, a synchronization signal used for the synchronization can be a low-power wake-up signal (power saving signal).

In an embodiment, the terminal monitors the power saving signal through the first transceiver; the processing operation of the second transceiver of the terminal is determined based on the determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; in response to the second transceiver being woke up, it performs synchronization with the network using the second transceiver; in response to the second transceiver being woke up and the terminal being synchronized with the network, monitoring for the paging message is started using the second transceiver. Herein, a synchronization signal used for the synchronization can be a low-power wake-up signal, a Synchronization Signal Block (SSB), a Tracking Reference Signal (TRS) or a Channel-State Information Reference Signal (CSI-RS).

It should be noted that those skilled in the art can understand that the method provided in the embodiment of the present disclosure can be performed alone or together with some methods in the embodiments of the present disclosure or some methods in related arts.

As shown in FIG. 8, an embodiment provides a monitoring method, the method is performed by a terminal, and the method includes the followings.

In step 81, in response to a second transceiver being woke up, monitoring of a paging message is started using the second transceiver.

In an embodiment, in response to the terminal being in an RRC non-connected state, the terminal monitors the power saving signal through a first transceiver; a processing operation for the second transceiver of the terminal is determined based on a determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, monitoring of a paging message is started using the second transceiver.

In some embodiments, in response to the second transceiver being woke up, periodic monitoring for the paging message is started using the second transceiver.

In an embodiment, the monitoring for the paging message may include: starting monitoring of PEI and/or PO based on paging parameters configured by the network, where the paging parameters include a DRX cycle and the like.

In an embodiment, in response to the second transceiver being woke up, aperiodic monitoring for the paging message is started using the second transceiver.

In an embodiment, the network sends in advance time-domain and/or frequency-domain position information for the terminal to search for PO, that is, search space and/or control resource set (CORESET) information. In an embodiment, the network sends in advance code-domain information for the terminal to search for PO for descrambling of monitoring of the paging message. The network can send it in a broadcasting manner or in a manner of sending dedicated signaling. In an embodiment, the dedicated signaling is an RRC release message.

In an embodiment, the time-domain position information, frequency-domain position information and/or code-domain information for the terminal to search for the PO may be pre-agreed upon through a predetermined protocol.

For example, the search space information indicates a predetermined search space used for receiving a paging message in a low power wake-up signal scenario. The search space may be scrambled using a predetermined scrambling method (different from the scrambling with a Paging Radio Network Temporary Identity (PRNTI) in the related art), such as Low power-PRNTI; where the DCI format may be a predetermined paging DCI format.

For example,

| | |
|---|---|
| PDCCH-ConfigCommon ::= | SEQUENCE { |
| controlResourceSetZero | ControlResourceSetZero |

OPTIONAL, -- Cond InitialBWP-Only

| | |
|---|---|
| commonControlResourceSet | ControlResourceSet |

OPTIONAL, -- Need R

| | |
|---|---|
| searchSpaceZero | SearchSpaceZero |

OPTIONAL, -- Cond InitialBWP-Only

| | |
|---|---|
| commonSearchSpaceList | SEQUENCE (SIZE(1..4)) OF SearchSpace |

OPTIONAL, -- Need R

| | |
|---|---|
| searchSpaceSIB1 | SearchSpaceId |

OPTIONAL, -- Need S

| | |
|---|---|
| searchSpaceOtherSystemInformation | SearchSpaceId |

OPTIONAL, -- Need S

| | |
|---|---|
| pagingSearchSpace | SearchSpaceId |

OPTIONAL, -- Need S

| | |
|---|---|
| pagingSearchSpace- LP-WUS | SearchSpaceId |

OPTIONAL, -- Need S

| | |
|---|---|
| ra-SearchSpace | SearchSpaceId |

OPTIONAL, -- Need S
...

and definition of Paging Control Channel (PCCH) is added:

| | |
|---|---|
| DownlinkConfigCommonSIB ::= | SEQUENCE { |
| frequencyInfoDL | FrequencyInfoDL-SIB, |
| initialDownlinkBWP | BWP-DownlinkCommon, |
| bcch-Config | BCCH-Config, |
| pcch-Config | PCCH-Config, |
| pcch-Config-LP-WUS | PCCH-Config- LP-WUS, |

...
}

In an embodiment, it needs not to define parameters such as a default paging cycle and paging frame offset (nAndPagingFrameOffset) in the PCCH configuration. In an embodiment, the network agrees in advance that certain downlink radio frames can be used as the transmission timing of PCCH. In this case, paging the terminal will no longer be performed according to its paging cycle, that is, the paging message is transmitted as soon as it arrives.

In an embodiment, the network can send multiple CORESETs and/or search spaces for carrying the Paging DCI. Herein, pagingSearchSpace-LP-WUS of different search spaces can be associated with different CORESETs. In this way, since the terminals are no longer distributed to different cycles and POs to monitor the paging message, in order to avoid the situation where many terminals are paged together which may result in impossible scheduling, they can be distinguished in the time domain/frequency domain/code domain (paging RNTI).

In an embodiment, the terminal selects different CORESETs and/or search spaces and/or paging RNTIs according to a predetermined rule, for example, the terminals are associated with different CORESETs and/or search spaces and/or code domain information according to an order of the UE-ID based subgrouping.

In an embodiment, the network sends in advance the offset of the low power PEI and/or PO, and when the terminal detects the low power PEI, it can locate a starting time point of the PEI and/or PO. In this case, the terminal can find the nearest PDCCH monitoring occasion (MO) position in the synchronization signal SS of the PEI and/or PO to perform monitoring.

It should be noted that those skilled in the art can understand that the method provided in the embodiment of the present disclosure can be performed alone or together with some methods in the embodiments of the present disclosure or some methods in related arts.

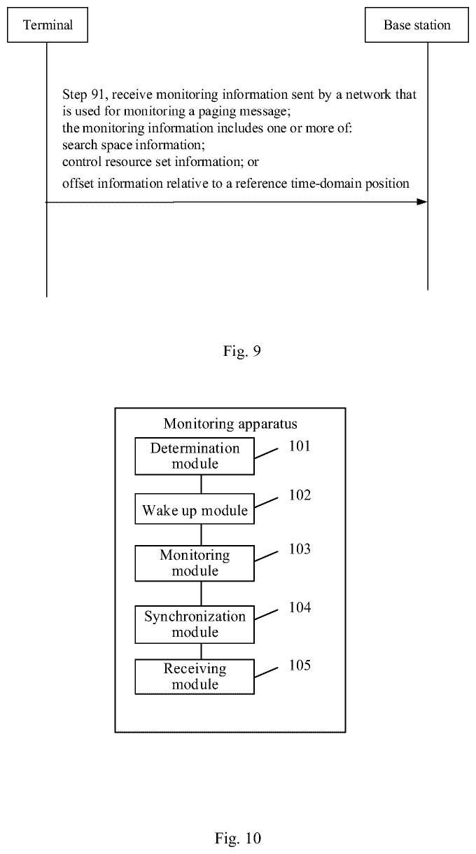

As shown in FIG. 9, an embodiment provides a monitoring method, the method is performed by a terminal, and the method includes the following.

In step 91, monitoring information sent by a network that is used for monitoring a paging message is received.

The monitoring information includes one or more of the following: search space information; control resource set information; or offset information relative to a reference time-domain position.

Herein, the search space information indicates a search space, and the control resource set information indicates a control resource set.

In an embodiment, the monitoring information sent by the network that is used for monitoring the paging message is received; where the monitoring information includes one or more of the following: search space information; control resource set information; or offset information relative to a reference time-domain position. In response to the terminal being in an RRC non-connected state, the terminal monitors a power saving signal through a first transceiver; a processing operation for a second transceiver of the terminal is determined based on a determination result of whether the first transceiver of the terminal detects the power saving signal; in response to determining that the power saving signal is detected, it is determined to wake up the second transceiver; and/or, in response to determining that the power saving signal is not detected, it is determined not to wake up the second transceiver; and in response to the second transceiver being woke up, monitoring of the paging message is started using the second transceiver and the monitoring information.

It should be noted that those skilled in the art can understand that the method provided in the embodiment of the present disclosure can be executed alone or together with some methods in the embodiments of the present disclosure or some methods in related arts.

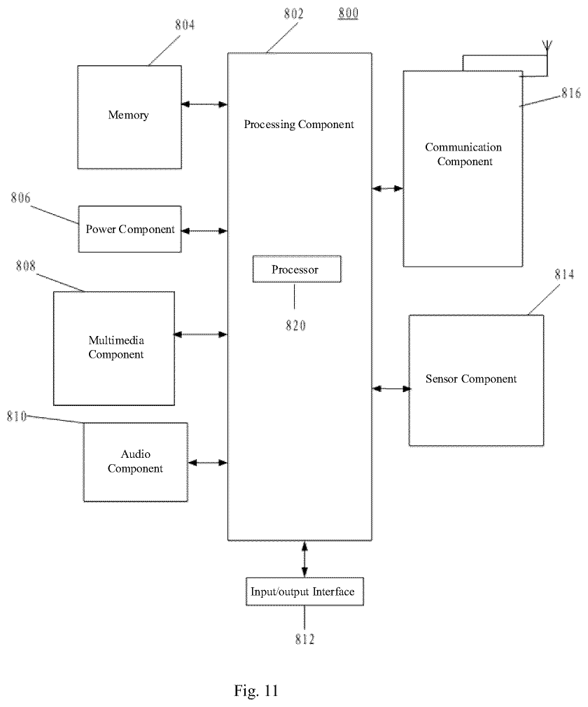

As shown in FIG. 10, an embodiment of the present disclosure provides a monitoring apparatus, and the apparatus includes: a determination module 101, configured to determine, based on a determination result of whether a power saving signal is detected by a first transceiver of a terminal, a processing operation for a second transceiver of the terminal.

The processing operation includes waking up the second transceiver or not waking up the second transceiver, the power consumption of the first transceiver is less than the power consumption of the second transceiver, the second transceiver is configured to monitor the paging message, and the terminal is a terminal in a radio resource control (RRC) non-connected state.

In an embodiment, the apparatus includes: a wake-up module 102, configured to:
in response to determining that the power saving signal is detected, wake up the second transceiver; and/or, in response to determining that the power saving signal is not detected, not wake up the second transceiver.

In an embodiment, the determining module 101 is configured to: determine, according to predetermined information, a radio resource for the first transceiver to monitor the power saving signal.

The predetermined information includes one or more of the following: network configured information; predetermined rule information sent by a network; or predetermined protocol information.

In an embodiment, the apparatus includes: a monitoring module 103, configured to: monitor a single set of power saving signals on the radio resource indicated by the network configured information, where the single set of power saving signals is used to wake up all terminals; and/or, monitor a plurality of sets of power saving signals on the radio resource indicated by the network configured information, where each set of power saving signals is used to wake up terminals in a group corresponding to the set of power saving signal, and the group includes at least one of the terminals.

In an embodiment, the apparatus includes: a monitoring module 103, configured such that the predetermined information indicates the terminal to determines the group to which the terminal belongs based on a terminal identifier UE-ID based subgrouping.

In an embodiment, the apparatus includes: a wake-up module 102, configured to: in response to determining to wake up the second transceiver, wake up the second transceiver of at least one of the terminals.

In an embodiment, the apparatus includes: a synchronization module 104, configured to: in response to the second transceiver being woke up, synchronize with a network using the first transceiver; or, in response to the second transceiver being woke up, synchronize with a network using the second transceiver.

In an embodiment, the apparatus includes: a monitoring module 103, configured to:
in response to the second transceiver being woke up, start monitoring of a paging message using the second transceiver.

In an embodiment, the monitoring module 103 is configured to: start periodic monitoring of the paging message using the second transceiver; or, start aperiodic monitoring of the paging message using the second transceiver.

In an embodiment, the apparatus includes: a receiving module 105, configured to receive monitoring information sent by a network that is used for monitoring a paging message.

The monitoring information includes one or more of the following: search space information; control resource set information; or offset information relative to a reference time-domain position.

It should be noted that those skilled in the art can understand that the method provided in the embodiment of the present disclosure can be executed alone or together with some methods in the embodiments of the present disclosure or some methods in related arts.

An embodiment of the present disclosure provides a communication device, and the communication device includes: a processor; and a memory configured to store instructions executable by the processor.

The processor is configured to implement the method applied to any of the embodiment of the present disclosure when running the executable instructions.

The processor may include various types of storage media, which are non-transitory computer storage media that can remain information stored thereon after the communication device is powered down.

The processor may be connected to the memory via a bus or the like to read the executable program stored on the memory.

An embodiment of the present disclosure further provides a computer storage medium, and the computer storage medium stores a computer executable program which, when being executed by a processor, implements the method of any of the embodiments of the present disclosure.

Regarding the apparatus in the above embodiments, the specific manner in which the modules perform operations has been described in detail in the embodiments of the methods, and will not be repeated here.

As shown in FIG. 11, an embodiment of the present disclosure provides a structure of a terminal.

Referring to FIG. 11, the present embodiment provides a terminal 800, which may be a mobile phone, a computer, a digital broadcast terminal, a messaging device, a game console, a tablet device, a medical device, a fitness device, a personal digital assistant, etc.

Referring to FIG. 11, the terminal 800 may include one or more of the following components: a processing component 802, a memory 804, a power component 806, a multimedia component 808, an audio component 810, an input/output (I/O) interface 812, a sensor component 814, and a communication component 816.

The processing component 802 generally controls the overall operation of the terminal 800, such as operations associated with display, phone calls, data communications, camera operations, and recording operations. The processing component 802 may include one or more processors 820 to execute instructions to complete all or part of the steps of the above method. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support operations on the device 800. Examples of such data include instructions for any application or method operating on the terminal 800, contact data, phone book data, messages, pictures, videos, etc. The memory 804 can be implemented by any type of volatile or non-volatile storage device or a combination thereof, such as a static random access memory (SRAM), an electrically erasable programmable read-only memory (EEPROM), an erasable Programmable read-only memory (EPROM), a programmable read-only memory (PROM), a read-only memory (ROM), a magnetic memory, a flash memory, a magnetic disk or an optical disk.

The power component 806 provides power to various components of the terminal 800. The power component 806 may include a power management system, one or more power supplies, and other components associated with generating, managing, and distributing power for the terminal 800.

The multimedia component 808 includes a screen that provides an output interface between the terminal 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, slide, and gestures on the touch panel. The touch sensor may not only sense the boundaries of the touch or slide action, but also detect the duration and pressure associated with the touch or slide operation. In some embodiments, the multimedia component 808 includes a front camera and/or a rear camera. When the device 800 is in an operating mode, such as a shooting mode or a video mode, the front camera and/or the rear camera may receive external multimedia data. Each of the front camera and rear camera may be a fixed optical lens system or have a focal length and optical zoom capability.

The audio component 810 is configured to output and/or input audio signals. For example, the audio component 810 includes a microphone (MIC), and when the terminal 800 is in an operation mode, such as a call mode, a recording mode, and a speech recognition mode, the microphone is configured to receive an external audio signal. The received audio signal can be further stored in the memory 804 or sent via the communication component 816. In some embodiments, the audio component 810 also includes a speaker for outputting audio signals.

The I/O interface 812 provides an interface between the processing component 802 and a peripheral interface module, which may be a keyboard, a click wheel, a button, etc. These buttons may include, but are not limited to, a home button, a volume button, a start button, and a lock button.

The sensor component 814 includes one or more sensors for providing status assessment of various aspects for the terminal 800. For example, the sensor component 814 can detect the open/closed state of the device 800, the relative positioning of the components, such as the display and keypad of the terminal 800, and the sensor component 814 can also detect a change in position of the terminal 800 or a component of the terminal 800, the presence or absence of user contact with the terminal 800, the orientation or acceleration/deceleration of the terminal 800 and the temperature change of the terminal 800. The sensor component 814 may include a proximity sensor configured to detect the presence of a nearby object without any physical contact. The sensor component 814 may also include an optical sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the terminal 800 and other devices. The terminal 800 can access a wireless network based on a communication standard, such as Wi-Fi, 2G or 3G, or a combination thereof. In an illustrative embodiment, the communication component 816 receives a broadcast signal or broadcast-related information from an external broadcast management system via a broadcast channel. In an illustrative embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an illustrative embodiment, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components to perform the above methods.

In an illustrative embodiment, a non-transitory computer-readable storage medium including instructions is also provided, such as a memory 804 including instructions, and the instructions can be executed by a processor 820 of the terminal 800 to perform the above methods. For example, the non-transitory computer-readable storage medium can be a ROM, a random access memory (RAM), a CD-ROM, a magnetic tape, a floppy disk, an optical data storage device, etc.

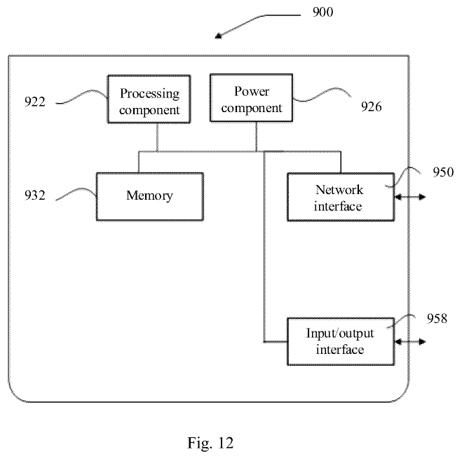

As shown in FIG. 12, an embodiment of the present disclosure illustrates a structure of a base station. For example, the base station 900 may be provided as a network-side device. Referring to FIG. 12, the base station 900 includes a processing component 922, which further includes one or more processors, and memory resources represented by a memory 932 which are configured to store instructions executable by the processing component 922, such as an application. The application stored in the memory 932 may include one or more modules, each module corresponding to a set of instructions. In addition, the processing component 922 is configured to execute instructions so as to perform any of the above methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™ or the like.

Those skilled in the art will readily appreciate other implementations of the present disclosure after considering the specification and practicing the present disclosure disclosed herein. The present disclosure is intended to cover any variations, uses or adaptations of the present disclosure that follow the general principles of the present disclosure and include common knowledge or conventional technical means in the art that are not disclosed in the present disclosure. It is intended that the description and examples be considered as illustrative only, with a true scope and spirit of the present disclosure being indicated by the following claims.

It should be understood that the present disclosure is not limited to the precise construction that has been described above and illustrated in the accompanying drawings, and that various modifications and changes may be made without departing from the scope thereof. The scope of the present disclosure is limited only by the appended claims.

1. A monitoring method, performed by a terminal, the method comprising:
determining, based on a determination result of whether a power saving signal is detected by a first transceiver of the terminal, a processing operation for a second transceiver of the terminal.

2. The method according to claim 1, wherein determining, based on the determination result of whether the power saving signal is detected by the first transceiver of the terminal, the processing operation for a second transceiver of the terminal comprises at least one of:
in response to determining that the power saving signal is detected, waking up the second transceiver; or
in response to determining that the power saving signal is not detected, not waking up the second transceiver.

3. The method according to claim 1, wherein the method further comprises:
determining, according to predetermined information, a radio resource for the first transceiver to monitor the power saving signal;
the predetermined information comprises one or more of:
network configured information;
predetermined rule information sent by a network; or
predetermined protocol information.

4. The method according to claim 3, wherein the predetermined information is the network configured information, and the method further comprises at least one of:
monitoring a single set of power saving signals on the radio resource indicated by the network configured information, wherein the single set of power saving signals is used to wake up all terminals; or
monitoring a plurality of sets of power saving signals on the radio resource indicated by the network configured information, wherein each set of the power saving signals is used to wake up a terminal in a group corresponding to the set of power saving signals, and the group comprises at least one terminal.

5. The method according to claim 3, wherein the method further comprises: determining the group to which the terminal belongs based on a terminal identifier UE-ID based subgrouping or based on received predetermined indication information.

6. The method according to claim 1, wherein the method further comprises:
in response to determining to wake up the second transceiver, waking up the second transceiver of at least one terminal.

7. The method according to claim 1, wherein the method further comprises:
in response to the second transceiver being woke up, synchronizing with a network using the first transceiver;
or,
in response to the second transceiver being woke up, synchronizing with a network using the second transceiver.

8. The method according to claim 1, wherein the method further comprises:
in response to the second transceiver being woke up, starting monitoring for a paging message using the second transceiver.

9. The method according to claim 8, wherein starting monitoring for the paging message using the second transceiver comprises:
starting periodic monitoring for the paging message using the second transceiver;
or,
starting aperiodic monitoring for the paging message using the second transceiver.

10. The method according to claim 9, wherein the method further comprises:
receiving monitoring information sent by a network that is used for monitoring the paging message;
the monitoring information comprises one or more of:
search space information;
control resource set information;
offset information relative to a reference time-domain position.

11.-20. (canceled)

21. A communication device, comprising:
a memory;
a processor, connected to the memory and configured to implement a monitoring method by executing computer executable instructions stored on the memory, the method comprising:
determining, based on a determination result of whether a power saving signal is detected by a first transceiver of a terminal, a processing operation for a second transceiver of the terminal.

22. A non-transitory computer storage medium having stored thereon computer executable instructions which, when being executed by a processor, cause the processer to:
determine, based on a determination result of whether a power saving signal is detected by a first transceiver of a terminal, a processing operation for a second transceiver of the terminal.

23. The communication device according to claim 21, wherein determining, based on the determination result of whether the power saving signal is detected by the first transceiver of the terminal, the processing operation for a second transceiver of the terminal comprises at least one of:
in response to determining that the power saving signal is detected, waking up the second transceiver; or
in response to determining that the power saving signal is not detected, not waking up the second transceiver.

24. The communication device according to claim 21, wherein the method further comprises:
determining, according to predetermined information, a radio resource for the first transceiver to monitor the power saving signal;
the predetermined information comprises one or more of:
network configured information;
predetermined rule information sent by a network; or
predetermined protocol information.

25. The communication device according to claim 24, wherein the predetermined information is the network configured information, and the method further comprises at least one of:
monitoring a single set of power saving signals on the radio resource indicated by the network configured information, wherein the single set of power saving signals is used to wake up all terminals; or
monitoring a plurality of sets of power saving signals on the radio resource indicated by the network configured information, wherein each set of the power saving signals is used to wake up a terminal in a group corresponding to the set of power saving signals, and the group comprises at least one terminal.

26. The communication device according to claim 24, wherein the method further comprises: determining the group to which the terminal belongs based on a terminal identifier UE-ID based subgrouping or based on received predetermined indication information.

27. The communication device according to claim 21, wherein the method further comprises:
in response to determining to wake up the second transceiver, waking up the second transceiver of at least one terminal.

28. The communication device according to claim 21, wherein the method further comprises:
in response to the second transceiver being woke up, synchronizing with a network using the first transceiver;
or,
in response to the second transceiver being woke up, synchronizing with a network using the second transceiver.

29. The communication device according to claim 21, wherein the method further comprises:
in response to the second transceiver being woke up, starting monitoring for a paging message using the second transceiver,
wherein starting monitoring for the paging message using the second transceiver comprises:
starting periodic monitoring for the paging message using the second transceiver;
or,
starting aperiodic monitoring for the paging message using the second transceiver.

30. The communication device according to claim 29, wherein the method further comprises:
receiving monitoring information sent by a network that is used for monitoring the paging message;
the monitoring information comprises one or more of:
search space information;
control resource set information;
offset information relative to a reference time-domain position.
